(19) United States
(12) Patent Application Publication
(10) Pub. No.: US 2015/0117038 A1
(43) Pub. Date: Apr. 30, 2015

(54) Mechanically adjustable light bulb for use in high temperature areas

(71) Applicant: ChefLED Inc., Brea, CA (US)

(72) Inventors: Eric Franquez Campos, Fullerton, CA (US); Philip George Franklin, Fullerton, CA (US)

(73) Assignee: ChefLED Inc., Brea, CA (US)

(21) Appl. No.: 13/998,449

(22) Filed: Oct. 31, 2013

(51) Int. Cl. F21K 99/00; F21V 29/00

(52) U.S. Cl. CPC F21K 9/135; F21V 29/22; F21Y 2101/02
USPC 362/382

(57) ABSTRACT

A sturdy mechanically adjustable light bulb, employing a semiconductor-based light source, is disclosed wherein the semiconductor light source is thermally isolated from the remaining portion of the light bulb assembly, so that the light source may be placed outside of thermally harsh climate located at the bulb's plug.

### CROSS-REFERENCE TO RELATED APPLICATIONS

This application claims priority to and the benefit of the filing of U.S. Provisional Patent Application Ser. No. 61/ 796,052, entitled “LED light with swivel head”, filed on Nov. 1, 2012, and the specification thereof is incorporated herein by reference.

This application is further related to Non-Provisional Patent Application Ser. No. 29/ 421,970, entitled “LED light with rotating and swiveling head”, filed on Nov. 1, 2012, and the specification thereof is incorporated herein by reference, and any benefits that may exist are claimed.

### FIELD OF THE INVENTION (TECHNICAL FIELD)

Embodiments of the present invention relate to lighting applications, especially pre-existing work lighting applications that employ incandescent lamps, wherein the otherwise placement of the light source is in an area that is too hot for the efficient use of newer lighting technology, or wherein the present lighting source is non-directional in nature, and the overall luminaire function would benefit from the use of a more energy-efficient more-directional light source.

In the preferred embodiment of the present invention, the field of the invention is more related to food hospitality markets, especially lighting applications that relate to hotplate food storage and staging areas, and hot food display and dispensing fixtures and work areas commonly requiring light sources which operate in elevated ambient temperatures.

### STATEMENT REGARDING FEDERALLY SPONSORED RESEARCH OR DEVELOPMENT

Neither this application nor the applicants hereto are subject to release of any rights to inventions made under federally sponsored research and development.

### COPYRIGHTED MATERIAL

Copyright 2013 by ChefLED Inc. This patent application and any resulting issued patent contains material that is subject to copyright protection. The owner has no objection to the facsimile reproduction by anyone of the application or the issued patent, as it appears in the Patent and Trademark Office patent file or records. However, the owner otherwise reserves all copyrights whatsoever.

### BACKGROUND OF THE INVENTION

Stainless steel cabinets and work surfaces are commonly found in the food preparation and hospitality industry because of their durability and ability to be easily cleaned. Some of these cabinets and work surfaces are heated either directly or indirectly in order to keep hot food hot, or to cook the food while placing it on display.

Infra-red heating is one common energy form used to indirectly heat or cook food. This is often true in restaurants that utilize infra-red heaters to create “hotplate areas” that indirectly warm plates and food as it is assembled by kitchen staff, and then to keep said plate and food warm while it awaits pick-up by waiters and floor staff.

One very common configuration of the infra-red warm food preparation and assembly area consists of a stainless steel surface that can accommodate plates lined-up next to each other, and installed directly above said surface is a second stainless steel assembly in the form of a hood that sits above the plates.

Within this hood assembly the infra-red heaters are mounted, typically within a mechanical channel, and also commonly sits a set of light bulbs which also sit within a common stainless steel channel.

The lighting channel typically consists of a u-shaped folded stainless steel sheet, to which a plurality of high-temperature lamp sockets are mounted so as to have the lamp bulbs mounted in the horizontal plane—in parallel to the stainless steel sheet. In this way light is direct down towards the food.

The light bulbs themselves are specialty glass-enclosed incandescent light bulbs that are specially manufactured to operate in high ambient temperatures, and said glass enclosures are further covered in plastic to prevent glass from contaminating food should a bulb be broken.

These bulbs operate in high ambient temperatures because the infrared heaters and hardware heat-up local air currents creating significant convective heat that wishes to rise and therefore gets trapped in the infra-red and lighting channels. Additionally, infra-red waves emanating from the infra-red heaters are directed towards the food where some of the energy in the waves is also converted from radiant heat into convective heat, and this convective heat again rises. Furthermore, some of the radiant infra-red wave energy misses the food surface and is instead reflected back up towards the hood assembly. Over time, the hood assembly begins to heat-up, and temperatures within the lighting channel can exceed 300 to 350 degrees Fahrenheit.

Because of the elevated ambient temperatures, the lifetime of the incandescent lamp is shorten, and as these specialty lamps are expensive both in terms of energy usage and cost to purchase, the industry could benefit greatly if they could use newer lighting technology. However, newer light technology that relies on chemical phosphors such as light-emitting diodes, are temperature sensitive when it comes to lifetime and emitted color temperatures, and therefore are not easily a replacement for the specialty bulb. Additionally, modifying the stainless steel fixtures to accommodate mounting some other form of luminaries is both expensive and troublesome given the food regulations and food preparation safety requirements.

### BRIEF SUMMARY OF THE INVENTION

A unique and special light bulb is designed. The light bulb is so designed so that it can be inserted and removed from the existing horizontally mounted light bulb sockets without modification to the lamp sockets or the stainless steel fixtures, greatly reducing installation costs and minimizing compliance and inspection requirements of the food safety agencies.

The light bulb employs a directed light source to minimize light energy that is otherwise misdirected or reflected at greater loss. The light bulb makes use of a modern energy-efficient light source generator and a specially designed heat sink to maximize dissipation of locally generated heat from that light source.

The light bulb further employs a complex mechanical mechanism to accomplish two design goals and requirements: The light emitter needs a means to direct light to the target work surface, and a second means for the heat sink of said light emitter to be so positioned as to be located outside of the lighting channel, thus avoiding the highest generated thermal temperatures.

The heat sink of the light emitter is further designed to minimize surfaces exposed to directly radiated infra-red energy from the infra-red generators, as well as surfaces exposed to surface-reflected infra-red energy emanating from the food plate surface.

The heat sink design further maximizes the use of air current channels designed to take advantage of the mixing of air currents by the thermal layers, said channels limited in scope and size by governmental and non-governmental food safety regulations and cleaning requirements.

The light-emitter end of the bulb is sealed with a clear lens assembly that may or may not have a light focusing or light distribution function. Said clear lens seals the light assembly and facilitates easy cleaning as required by governmental and non-governmental food safety agencies.

The mechanical adjustment mechanisms are so designed to maximize physical robustness of the lamp bulb as well as maximize protection of the current-carrying wires located within the bulb assembly. Furthermore the surfaces of said mechanical swivel and angle assembly are so designed as to minimize the ability to house or attract food, dirt, oils, or dust, and to facilitate easy cleaning.

### BRIEF DESCRIPTION OF THE SEVERAL VIEWS OF THE DRAWING

The drawings, which are incorporated herein, illustrate the background of the invention and one or more embodiments of the present invention, thus helping to better explain one or more aspects of the one or more embodiments. As such, the drawings are not to be construed as limiting any particular aspect of any embodiment of the invention. In the drawings:

FIG. 1 is an illustration of a typical hotplate preparation area as found in many restaurants. This is useful for a review of the background of the invention.

FIG. 2 is an illustration of the same typical hotplate preparation area with an embodiment of the invention inserted to help explain the application.

FIG. 3 is an exploded view of one embodiment of the invention, demonstrating the subassembly and parts that make-up this particular embodiment of the invention.

FIG. 4 is also an exploded view of an embodiment of the invention, further demonstrating the mechanical rotations and fit of the subassembly and parts that make-up this particular embodiment of the invention.

FIG. 5 shows the invention in a 90 degree tilt position.

FIG. 6 shows the invention in the expected most-common configuration.

### DETAILED DESCRIPTION OF THE INVENTION

As used throughout this specification and claims, “warm food preparation and assembly area” and “hotplate assembly area” are used as general terms to describe areas or assemblies of furniture or fixtures wherein hot food may be kept warm either during the plate assembly process, such as when a potato may be added to a plate that already has a steak placed on it, or when meals have been plated and ready to deliver to a table, but floor staff have yet had time to make said delivery.

As used throughout this specification and claims, “warm food preparation and assembly area” and “hotplate assembly area” or any other similar wording used in examples should not be construed as limiting the application of the invention. Indeed, application of the invention to open or enclosed hot dog cooking and display cases, popcorn machines and display cases, and all other applications of the invention that would benefit from the increased ambient temperature operation capabilities of the LED or OLED light source are anticipated. Furthermore, applications of the invention that benefit solely from the ability to direct the emitted light even without the need for increased ambient operation are also anticipated.

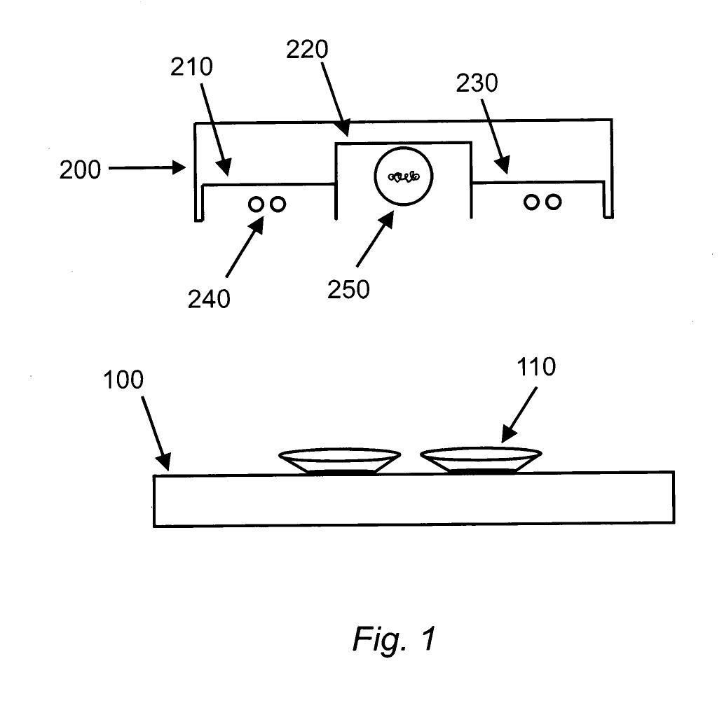

In FIG. 1, we further demonstrate and explore the background of the invention for one or more of the embodiments of the present invention. 100 illustrates a table top or shelf top where plates 110 with may be placed so that food may be assembled upon them. Often the table top 100 is made of stainless steel sheet metal.

Also in FIG. 1, 200 points to a stainless steel sheet metal shell that is made into the form of a hood assembly. In this instance, the shell contains three cavities or channels. 210 and 230 illustrate the channels that contain the infrared generation rods 240. These rods 240 when energized with electrical energy will rise in temperature and then glow, emitting infra-red radiant energy that is used to warm the plates and keep the hot foods hot. The ambient temperature in these infra-red channels (210 and 230) can reach 500 degrees C.

Also in FIG. 1, 220 points to a lighting channel that is often found in these hood assemblies. Lights are necessary in order to see the plates and see the clear placement of the food items. In this instance, we see a typical oven rated incandescent lamp bulb 250 installed in the channel. This lamp bulb must be rated and manufactured to operate in high-temperature ambient conditions, as the temperature in this lighting channel 220 can reach 300 degrees C.

Because of governmental and non-governmental food safety regulations and agencies, bulb 250 is a glass bulb that is in turn encased in a high temperature plastic casing, so that the chance of glass being introduced into food should the bulb break is minimalized.

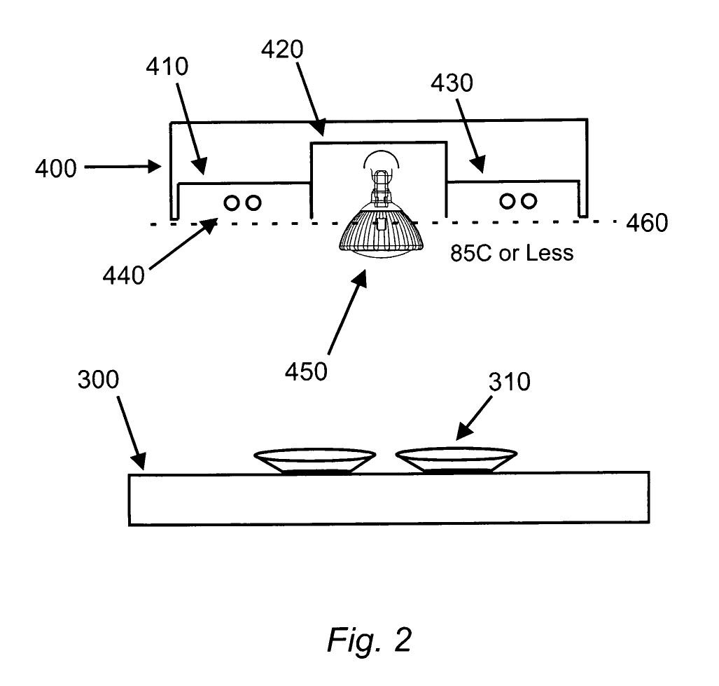

In FIG. 2, we see the same type of warm food preparation facility as in FIG. 1, but this time with one embodiment of the present invention illustrated in application.

Continuing in FIG. 2, 400 points to a stainless steel sheet metal shell that is made into the form of a hood assembly. As before, the shell contains three cavities or channels. 410 and 430 illustrate the channels that contain the infra-red generation rods 440. As before, the ambient temperature in these infra-red channels (410 and 430) can reach 300 degrees C.

420 points to the lighting channel as discussed previously, but this time one embodiment of the invention 450 is installed in the channel instead of an incandescent lamp. As previously noted, the ambient temperature in lighting channel 420 can reach 300 degrees C. near the top of the channel. 460 illustrates the bottom edge of the channel, where the ambient temperature of this thermal layer is 85 degrees C. or less. Taken together, FIG. 2 helps to illustrate that the embodiment of the invention 450 has at least one part of its assembly positioned in a thermal layer that is 85 degrees C. or less (sheet metal edge 460 and below), later on it will be illustrated that this part of the assembly of the invention functions as it's heat sink.

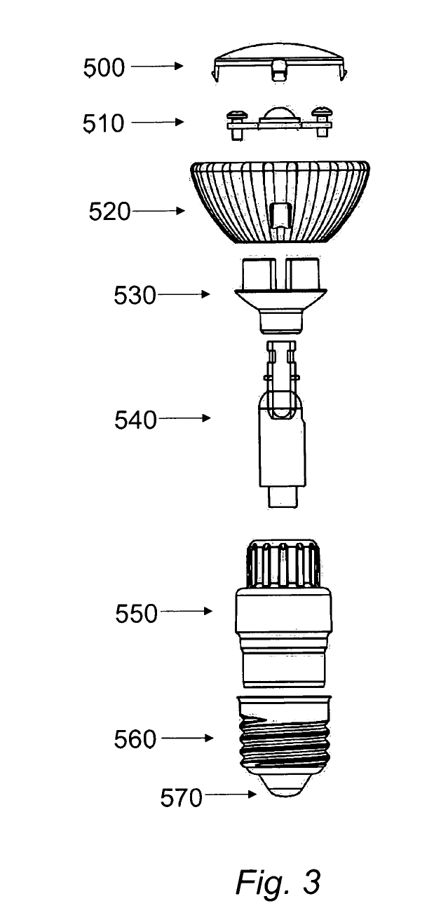

In FIG. 3 we have an exploded view of the preferred embodiment of the invention, which is an LED-based embodiment of the invention utilizing an Edison-style 26 mm electrical screw base. 500 is a clear polycarbonate lens that is designed to withstand high temperature exposure and remain significantly impact resistant even when heated. 500 seals the LED light engine and printed circuit board 510 from exposure to food, steam, and grease, and facilitates ease of cleaning as required by food agencies. The 510 LED light engine printed circuit board is of special construction, employing an aluminum base so that maximum heat spread and conductivity are assured.

520 is the primary heat sink to which the LED light engine 510 is mounted to, and the lens assembly 500 snaps into and seals against. A thermally-conductive compound (not illustrated) is applied between the bottom of the 510 LED light engine and printed circuit board, and the inside surface of the 520 heat sink to which the 510 fits into, thus further assuring maximum thermal conductivity from the LED die on 510 circuit board to the 520 heat sink. The 520 heat sink is so designed to minimize surfaces that are directly exposed to infrared wave energy including the bottom ring edge of the heat sink to which the 500 lens sits into and seals. The outside surface of the heat sink is ribbed to maximize surface area for thermal transfer to the ambient temperature air the 520 heat sink sits in, yet said ribs are of such design so as to minimize collection of food particles or grease, and facilitate ease of cleaning.

Still in FIG. 3, 530 is a custom molded adapter and thermal insulator made of special high-temperature fibrous nylon material. The function of the 530 adapter is to allow mechanical connection to the 520 heat sink, but minimize downward thermal conductivity from other metal parts of the preferred embodiment that are exposed to the higher ambient temperatures of the 420 lighting channel of the hood assembly.

540 of FIG. 3 is a multi-part metal assembly that allows two axis of movement or adjustment. The first axis of movement facilitated by 540 is along the axis of the preferred embodiment as displayed in FIG. 3. That is, if the 520 heat sink were to be held fixed and steady, the 540 assembly would still allow twisting of the 560 Edison-style screw plug up to 350 degrees.

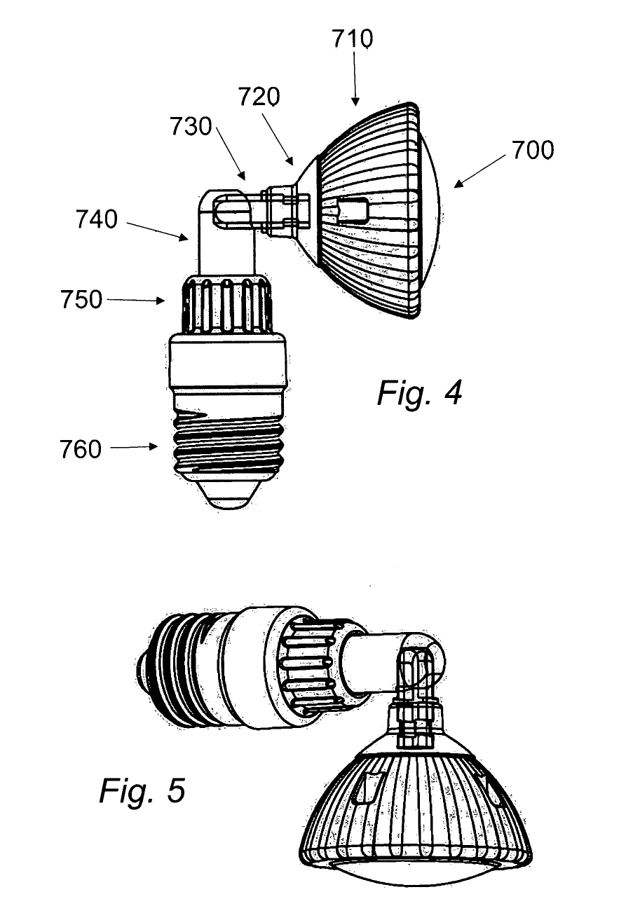

The second axis of adjustment of the 540 of FIG. 3 is up to a 110 degree quasi-perpendicular angle of the 520 heat sink, 530 adapter, 510 light engine circuit board, and 500 lens assembly, from the first axis of the preferred embodiment. That is, given the 520 heat sink, 530 adapter, 510 light engine circuit board, and 500 lens assembly, are hereinafter referred to as the light head assembly; then the second axis of movement would be to allow the light head assembly to be rotated to face the viewer of the FIG. 3 diagram straight on. This is better illustrated later on in FIG. 4.

550 of FIG. 3, in a similar fashion to that of 530, is a custom molded adapter and thermal insulator made of special high-temperature fibrous nylon material. The function of the 550 adapter is three-fold: To allow mechanical connection from the 540 mechanical assembly to the 560 electrical plug; To thermally and electrically isolate the metal parts of the 540 to the higher ambient temperatures and electrical currents of the 560 electrical plug; and to facilitate ease of installation of the preferred embodiment into an open bulb socket by supplying finger ridges that facilitate a human grasping the device to screw it into or out of a lamp socket.

Finally in FIG. 3, 560 of the preferred embodiment of the invention utilizes a 26 mm diameter Edison screw plug. This is the standard for the North American markets. Nothing herein should be construed as to limit the electrical connection to be anyone device, style, or standard. For example, a 27 mm diameter Edison plug for use in certain European markets is anticipated, as well as bi-pin plugs for use in industry.

What is not illustrated in FIG. 3 is the wiring between the 560 screw plug and the 510 light engine printed circuit board. There are two wires that are high temperature rated and use an insulating jacket material that resists abrasions, scoring, and scratches. For the plug-end of the wires, one attaches to the 560 Edison shell, while the other wire attaches to the 570 center pin and contact of the Edison shell. The other ends of the wires terminate on the 510 light engine printed circuit board.

In FIG. 4, the preferred embodiment of the invention is shown in a 90-degree bent position. 700 is the polycarbonate lens and 710 is the heat sink. Internal to these two pieces is the LED light engine circuit board which is not visible from this angle. 720 is the custom molded adapter and thermal insulator made of special high-temperature fibrous nylon material. Items 700, 710, and 720, taken together, constitute the light head assembly, which the invention facilitates a wide range of adjustment from axis center.

730 and 740 are two subassemblies of the 540 multi-part metal assembly that permits two axis of movement or adjustment. The 740 is the sleeve portion that allows for rotation in the 750 housing of up to 350 degrees along the main axis, and the 730 is the swivel joint that facilitates a bending off from center of 110 degrees.

760 is a side view of the Edison plug.

FIG. 5 is a simple depiction of the preferred embodiment of the invention is the physical orientation that the invention should most often be found.

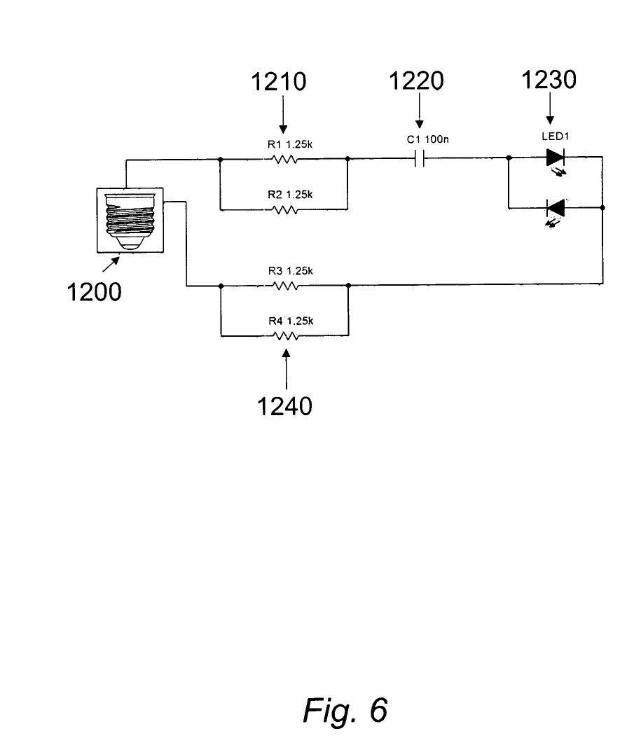

FIG. 6 is the electrical schematic of the preferred embodiment of the invention, which is targeted to a 120 Volt AC, 50-60 Hertz application of the bulb. 1200 is again the Edison-style bulb plug. Resistor 1 (1210) and Resistor 2 (1250) are two 1.25K Ohm EIA 1210-sized resistors that together in parallel create an equivalent 750 Ohm resistor with enough power capacity to not create an internal heat source on the printed circuit board. In a similar fashion, Resistor 3 (1240) and Resistor 4 (1260) are also two 1.25K Ohm EIA 1210-sized resistors that together in parallel create an equivalent 750 Ohm resistor with enough power capacity to not create an internal heat source on the printed circuit board. All told, all four 1210, 1240, 1250, and 1260 resistors create an equivalent series resistance of 1500 Ohms. Capacitor C1 (1220) and LED1 (1230) complete the circuit. LED1 (1230) is a Samsung “HV-AC Series” Light Emitting Diode, Model SPHWHTHAD605S0WOU4. C1 (1220) is a 0.1 uF 350V Capacitor. Nothing in the schematic herein should be taken to limit the circuitry as to voltages anticipated or as to circuit complexity. Indeed, it is anticipated that additional circuitry may be needed in some instances to pass noise or distortion tests and requirements of some foreign governments. Furthermore, several bulb operating voltages and power types are anticipated including 120 Volt, 220 Volt, 240-277 Volt, and both AC and DC voltage operation.

Furthermore, FIG. 6 depicts the use of LED 1230 which is designated as a Samsung model SPHWHTHAD605S0WOU4. Nothing herein should be taken to limit the light engine design or options to this particular light emitting diode or even to light emitting diode technology only. Indeed it is anticipated that some embodiments of the invention will use a multiplicity of light emitting diodes or even a light emitting diode array. Organic light emitting diode technology is also anticipated as use as a lighting engine.

It is also anticipated that in some applications a Peltier-effect cooler operating as a solid state thermoelectric heat pump in conjunction with the invention's heat sink may be desired or necessary to meet operating parameters of some applications. Said solid state thermoelectric heat pump sandwiching itself between the FIG. 3 510 light engine circuit board and the 520 heat sink.

It is also anticipated that in some applications it will be desirable to extend the distance from the light head assembly and the plug, and therefore an a third axis of adjustment of the invention is anticipated.

We claim:

1. A light bulb, consisting of a plug means, a means of light generation, a mechanical means of rotation of said means of light generation along the axis of the lamp bulb, and a means of articulation of said means of light generation away from the axis of the lamp.

2. The lamp bulb of claim 1, wherein said means of light generation is one or more light emitting diode.

3. The lamp bulb of claim 1, wherein said means of light generation includes a heat sink, with or without an active thermoelectric heat pump incorporated into the design.

4. A light bulb, consisting of a plug means, a means of light generation, a mechanical means of fixed or adjustable spacing of the plug means with that of the means of light generation, with further means of mechanical rotation of said means of light generation along the main axis of the lamp, and means of articulation of said means of light generation away from the axis of the lamp.

5. The lamp bulb of claim 4, wherein said means of light generation is one or more light emitting diode.

6. The lamp bulb of claim 4, wherein said means of light generation includes a heat sink, with or without an active thermoelectric heat pump incorporated into the design.

7. A light bulb, employing a semiconductor light source, wherein the light source is designed to be thermally isolated from the lamp plug.

8. The lamp bulb of claim 7, wherein the means of light generation is one or more light emitting diode.

9. The lamp bulb of claim 7, wherein said means of light generation includes a heat sink, with or without an active thermoelectric heat pump incorporated into the design.
